(19) United States
(12) Patent Application Publication
(10) Pub. No.: US 2014/0234708 A1
(43) Pub. Date: Aug. 21, 2014

(54) ELECTRODE FOR RECHARGEABLE LITHIUM BATTERY, METHOD OF PREPARING THE SAME AND RECHARGEABLE LITHIUM BATTERY INCLUDING SAME

(71) Applicant: Samsung SDI Co., Ltd., Yongin-si (KR)

(72) Inventors: Hyun-Ki Park, Yongin-si (KR); Dong-Hee Han, Yongin-si (KR); Jae-Myung Kim, Yongin-si (KR); Sang-Eun Park, Yongin-si (KR); Su-Kyung Lee, Yongin-si (KR)

(73) Assignee: Samsung SDI Co., Ltd., Yongin-si (KR)

(21) Appl. No.: 14/136,590

(22) Filed: Dec. 20, 2013

(30) Foreign Application Priority Data
Feb. 20, 2013 (KR) 10-2013-0018205

(51) Int. Cl. H01M 4/134; H01M 4/1393; H01M 4/04

(52) U.S. Cl. CPC H01M 4/134; H01M 4/0404; H01M 4/1393
USPC 429/211; 252/500; 252/511

(57) ABSTRACT

In an aspect, an electrode for a rechargeable lithium battery, a method of preparing the same, and a rechargeable lithium battery including the same are provided.

### INCORPORATION BY REFERENCE TO RELATED APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0018205 filed in the Korean Intellectual Property Office on Feb. 20, 2013, the disclosure of which are incorporated herein by reference in its entirety.

### BACKGROUND

1. Field

This disclosure relates to an electrode for a rechargeable lithium battery, a method of preparing the same, and a rechargeable lithium battery including the same.

2. Description of the Related Technology

Rechargeable lithium batteries have recently drawn attention as a power source for small portable electronic devices. They use an organic electrolyte and may have twice or more the discharge voltage of a conventional battery using an alkali aqueous solution, and accordingly have high energy density.

A rechargeable lithium battery manufactured by injecting an electrolyte into an electrode assembly including a positive electrode including a positive active material that can intercalate and deintercalate lithium, and a negative electrode including a negative active material that can intercalate and deintercalate lithium.

Graphite, generally used as a negative active material, has an active mass density of about 1.5 g/cc to about 1.7 g/cc. When the high active mass density is greater than or equal to about 1.8 g/cc, the permeation time for an electrolyte solution with a negative electrode is delayed, and not all the electrolyte has time to interact with the negative electrode. In addition, in an electrode having a high active mass density, when the electrolyte solution is depleted, the electrolyte solution that was unable to interact with the electrode may permeate the electrode, but the efficiency is not ideal since the electrode plate has a high active mass density. Thereby, the cycle-life of battery may be deteriorated.

### SUMMARY

One embodiment provides an electrode for a rechargeable lithium battery having improved battery cycle-life characteristics and improved charge and discharge characteristics at a high rate since the impregnating path of electrolyte solution or the electrolyte solution reservoir may be secured in the electrode, even in the electrode having a high active mass density.

Another embodiment provides a method of preparing the electrode for a rechargeable lithium battery.

Yet another embodiment provides a rechargeable lithium battery including the electrode for a rechargeable lithium battery.

One embodiment provides an electrode for a rechargeable lithium battery that includes a current collector; and an electrode active material layer disposed on the current collector, wherein the electrode active material layer includes an electrode active material, a binder, an acrylonitrile-based resin, and one or more pores.

In some embodiments, the acrylonitrile-based resin may be included in an amount of about 0.001 wt % to about 1.1 wt % based on the total amount of the electrode active material layer.

In some embodiments, the pore may have a size of about 0.1 μm to about 100 μm, and a volume of about 15 volume % to about 40 volume %.

In some embodiments, the electrode active material may include natural graphite, artificial graphite, Si, SiOₓ (0<x<2), a Si-containing alloy, Sn, SnO₂, a Sn-containing alloy, Ag, Al, or a combination thereof.

In some embodiments, the electrode may have an active mass density of about 1.60 g/cc to about 2.2 g/cc.

In some embodiments, the electrode may have an impregnating rate of an electrolyte solution increased by about 20 volume % to about 80 volume % relative to an electrode without an acrylonitrile-based resin.

In some embodiments, the electrode may have an adherence force of about 0.6 gf/mm to about 3.5 gf/mm.

Another embodiment provides a method of preparing an electrode for a rechargeable lithium battery that includes coating an electrode active material layer composition on a current collector, wherein the electrode active material layer composition includes an electrode active material, a binder, and a foaming agent including an acrylonitrile-based resin.

In some embodiments, the foaming agent may be a particle having an average diameter in the range of about 2 μm to about 100 μm.

In some embodiments, the foaming agent may be included in an amount of about 0.001 wt % to about 1.1 wt % based on the total amount of the electrode active material layer.

Yet another embodiment provides rechargeable lithium battery including the electrode; and an electrolyte solution impregnated in the electrode.

In some embodiments, the rechargeable lithium battery having improved cycle-life characteristics and improved charge and discharge characteristics at a high rate may be accomplished by securing an impregnating path and a reservoir of electrolyte solution in the electrode, even in such an electrode having a high active mass density.

### BRIEF DESCRIPTION OF THE DRAWINGS

FIG. 1 is a schematic view showing a rechargeable lithium battery according to one embodiment.

FIG. 2 is a scanning electron microscope (SEM) photograph of a negative electrode according to Example 3.

FIG. 3 is a scanning electron microscope (SEM) photograph of a negative electrode according to Comparative Example 1.

FIG. 4 is a graph showing charge and discharge characteristics at a high rate of a rechargeable lithium battery cells according to Example 2 and Comparative Example 1.

FIG. 5 is a graph showing cycle-life characteristics of a rechargeable lithium battery cells according to Example 1 and Comparative Examples 1 and 2.

### DETAILED DESCRIPTION

Exemplary embodiments will hereinafter be described in detail. However, these embodiments are only exemplary, and the present disclosure is not limited thereto.

Some embodiments provide an electrode for a rechargeable lithium battery including a current collector and an electrode active material layer disposed on the current collector, wherein the electrode active material layer includes an electrode active material, a binder, an acrylonitrile resin, and a pore.

In some embodiments, the electrode may be an electrode having a high active mass density of about 1.60 g/cc to about 2.2 g/cc. In some embodiments, the electrode may be an electrode having a high active mass density of about 1.70 g/cc to about 2.2 g/cc. In some embodiments, the electrode may be an electrode having a high active mass density of about 1.80 g/cc to about 1.96 g/cc.

According to one embodiment, since the pore is present in the electrode active material layer, the impregnating path of electrolyte solution may be secured, or the electrolyte solution reservoir may be secured even in the electrode having a high active mass density. By using the electrode, the rechargeable lithium battery may have a high capacity, and improved cycle-life characteristics and improved charge and discharge characteristics at a high rate.

In some embodiments, the pore formed in the electrode, specifically, the electrode having an active mass density of about 1.60 g/cc to about 2.2 g/cc, may have a size of about 0.1 μm to about 100 μm. In some embodiments, the pore formed in the electrode may have a size of about 0.1 μm to about 100 μm and the electrode may have a high active mass density of about 1.70 g/cc to about 2.2 g/cc. In some embodiments, the pore formed in the electrode may have a size of about 0.1 μm to about 100 μm and the electrode may have a high active mass density of about 1.80 g/cc to about 1.96 g/cc. In some embodiments, the pore formed in the electrode may have a size of about 0.1 μm to about 10 μm and the electrode may have a high active mass density of about 1.70 g/cc to about 2.2 g/cc. In some embodiments, the pore formed in the electrode may have a size of about 0.1 μm to about 10 μm and the electrode may have a high active mass density of about 1.80 g/cc to about 1.96 g/cc. In some embodiments, the pore formed in the electrode may have a size of about 3 μm to about 10 μm and the electrode may have a high active mass density of about 1.70 g/cc to about 2.2 g/cc. In some embodiments, the pore formed in the electrode may have a size of about 3 μm to about 10 μm and the electrode may have a high active mass density of about 1.80 g/cc to about 1.96 g/cc. In some embodiments, the pore formed in the electrode may have a size of about 5 μm to about 10 μm and the electrode may have a high active mass density of about 1.70 g/cc to about 2.2 g/cc. In some embodiments, the pore formed in the electrode may have a size of about 5 μm to about 10 μm and the electrode may have a high active mass density of about 1.80 g/cc to about 1.96 g/cc. In some embodiments, the pore size may depend upon the active mass density and type of foaming agent. The size of the pores formed by using foaming agent may range from about 0.1 μm to about 10 μm, specifically, from about 3 μm to about 10 μm, and further specifically, from about 5 μm to about 10 μm. When the pore has the size within the range, since large space is provided in the electrode having a high active mass density, the electrolyte solution may be easily impregnated by securing the impregnating path of electrolyte solution, and the depletion region of electrolyte solution is absent by providing the electrolyte solution reservoir. The size of pore refers to length of a pore.

In some embodiments, the electrode including a pore volume in the electrode having an active mass density of about 1.60 g/cc to about 2.2 g/cc may decrease, compared to a pore volume in electrode having a lower active mass density. In some embodiments, the electrolyte solution may be dispersed in the electrode in more uniformly by using the foaming agent even though the porosity is decreased. The pore may have a volume of, for example, about 15 volume % to 40 volume %.

In some embodiments, the pore may be formed from the foaming agent used for forming the electrode active material layer.

In some embodiments, the foaming agent has a core and shell structure, and the shell may include an acrylonitrile-based resin, and the core may include a hydrocarbon material other than the acrylonitrile-based resin. In some embodiments, the foaming agent having a core and shell structure may be microcapsules of thermoplastic resin such as Matsumoto Microsphere®F and FN Series (Matsumoto Yushi-Seiyaku Co., Ltd, Osaka JP). Within the predetermined temperature range, the hydrocarbon material positioned in the core is gasified to expand the foaming agent; and at a temperature range of less than or equal to about 160° C. which is a drying temperature range of an electrode after being vacuum dried (VD), the foaming agent is contracted. The sized pore is provided in the electrode formed through the process, and an acrylonitrile-based resin remains. Specifically, due to the gasification of the hydrocarbon material, the pore is provided in the electrode, and the acrylonitrile-based resin is cut and crushed according to the expansion and contraction of the foaming agent which remains in the electrode. The vacuum drying (VD) is a process of storing the obtained electrode in a vacuum chamber at a temperature of about 130° C. to 160° C. for greater than or equal to about 5 hours to remove moisture. In some embodiments, the foaming agent may be a resin such as CAPL3 (Kum Yang, Seoul, KR; CAPL3).

In some embodiments, the shell may have a thickness of about 0.1 μm to about 10 μm, and specifically about 0.1 μm to about 5 μm.

In some embodiments, the foaming agent may be a particle having an average diameter in the range of about 2 μm to about 100 μm, and specifically about 10 μm to about 80 μm. The size of foaming agent may be changed according to the expansion and contraction within the size range.

By presenting the acrylonitrile-based resin in the electrode active material layer, the impregnation property of electrolyte solution is improved, and the adherence force of electrode is also enhanced. Due to the binder, the binding force between the acrylonitrile-based resins is increased to further enhance the adherence force of the electrode.

In some embodiments, the acrylonitrile-based resin may be, for example, a polyacrylonitrile resin.

In some embodiments, the acrylonitrile-based resin may be included in an amount of about 0.001 wt % to about 1.1 wt %, and specifically about 0.005 wt % to about 0.2 wt % based on the total amount of the electrode active material layer. When the acrylonitrile-based resin is present in the electrode within the range, the impregnation property of electrolyte solution is improved, and also the adherence force of the electrode may be enhanced.

In some embodiments, the electrode active material may be any positive active material and negative active material that has been used in a rechargeable lithium battery.

Specifically, the positive active material may be a compound (lithiated intercalation compound) that may reversibly intercalate or deintercalate lithium, for example compounds represented by the following chemical formulae.

LiₐA_{1-b}B_{b}D¹₂ (0.90≦a≦1.8 and 0≦b≦0.5); LiₐE_{1-b}B¹_{b}O_{2-c}D_{c} (0.90≦a≦1.8, 0≦b≦0.5, 0≦c≦0.05); LiE_{2-b}B¹_{b}O_{4-c}D¹_{c} (0≦b≦0.5, 0≦c≦0.05); LiₐNi_{1-b-c}Co_{b}B¹_{c}D¹_{α} (0.90≦a≦1.8, 0≦b≦0.5, 0≦c≦0.05, 0<α≦2); LiₐNi_{1-b-c}Co_{b}B¹_{c}O_{2-α}F¹_{α} (0.90≦a≦1.8, 0≦b≦0.5, 0≦c≦0.05, 0<α<2); LiₐNi_{1-b-c}Co_{b}B¹_{c}O_{2-α}F¹₂ (0.90≦a≦1.8, 0≦b≦0.5, 0≦c≦0.05, 0<α<2); LiₐNi_{1-b-c}Mn_{b}B¹_{c}D¹_{α} (0.90≦a≦1.8, 0≦b≦0.5, 0≦c≦0.05, 0<α≦2); LiₐNi_{1-b-c}Mn_{b}B¹_{c}O_{2-α}F¹_{α} (0.90≦a≦1.8, 0≦b≦0.5, 0≦c≦0.05, 0<α<2); LiₐNi_{1-b-c}Mn_{b}B¹_{c}O_{2-α}F¹₂ (0.90≦a≦1.8, 0≦b≦0.5, 0≦c≦0.05, 0<α<2); LiₐNi_{b}E_{c}G_{d}O₂(0.90≦a≦1.8, 0≦b≦0.9, 0≦c≦0.5, 0.001≦d≦0.1.); LiₐNi_{b}Co_{c}Mn_{d}GeO₂ (0.90≦a≦1.8, 0≦b≦0.9, 0≦c≦0.5, 0≦d≦0.5, 0.001≦e≦0.1.); LiₐNiG_{b}O₂ (0.90≦a≦1.8, 0.001≦b≦0.1.); LiₐCoG_{b}O₂ (0.90≦a≦1.8, 0.001≦b≦0.1.); LiₐMnG_{b}O₂ (0.90≦a≦1.8, 0.001≦b≦0.1.); LiₐMn₂G_{b}O₄ (0.90≦a≦1.8, 0.001≦b≦0.1.); QO₂; QO₂; QS₂; LiQS₂; V₂O₅; LiV₂O₅; LiI¹O₂; LiNiVO₄; Li_{(3-f)}J₂(PO₄)₃(0≦f≦2); Li_{(3-f)}Fe₂(PO₄)₃(0≦f≦2); and LiFePO₄.

In the above chemical formulae, A may be selected from Ni, Co, Mn, or a combination thereof; B¹ may be selected from Al, Ni, Co, Mn, Cr, Fe, Mg, Sr, V, a rare earth element, or a combination thereof; D¹ may be selected from O (oxygen), F (fluorine), S (sulfur), P (phosphorus), or a combination thereof; E may be selected from Co, Mn, or a combination thereof; F¹ may be selected from F (fluorine), S (sulfur), P (phosphorus), or a combination thereof; G may be selected from Al, Cr, Mn, Fe, Mg, La, Ce, Sr, V, or a combination thereof; Q may be selected from Ti, Mo, Mn, or a combination thereof; I¹ may be selected from Cr, V, Fe, Sc, Y, or a combination thereof; and J may be selected from V, Cr, Mn, Co, Ni, Cu, or a combination thereof.

In some embodiments, the negative active material includes a material that reversibly intercalates/deintercalates lithium ions, a lithium metal, a lithium metal alloy, a material being capable of doping/dedoping lithium, or a transition metal oxide.

In some embodiments, the material that can reversibly intercalate/deintercalate lithium ions includes a carbon material. The carbon material may be any generally-used carbon-based negative active material in a rechargeable lithium battery. Examples of the carbon material include crystalline carbon, amorphous carbon, and mixtures thereof. In some embodiments, the crystalline carbon may be non-shaped, or sheet, flake, spherical, or fiber shaped natural graphite or artificial graphite. In some embodiments, the amorphous carbon may be a soft carbon, a hard carbon, a mesophase pitch carbonization product, fired coke, and the like.

In some embodiments, the lithium metal alloy may include alloys of lithium and a metal selected from Na, K, Rb, Cs, Fr, Be, Mg, Ca, Sr, Si, Sb, Pb, In, Zn, Ba, Ra, Ge, Al, and Sn.

In some embodiments, the material being capable of doping/dedoping lithium may include Si, SiOₓ (0<x<2), a Si—C composite, a Si—Y alloy (wherein Y is selected from an alkali metal, an alkaline-earth metal, Group 13 to Group 16 elements, a transition element, a rare earth element, and a combination thereof, and not Si), Sn, SnO₂, a Sn—C composite, a Sn—Y alloy (wherein Y is selected from an alkali metal, an alkaline-earth metal, Group 13 to Group 16 elements, transition elements, a rare earth element, and a combination thereof, but not Sn), and the like. In some embodiments, at least one thereof may be mixed with SiO₂. In some embodiments, the element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof. In some embodiments, element Y may be Mg, Ca, Sr, Ba, Ra, Sc, Y, Ti, Zr, V, Nb, Ta, Cr, Mo, W, Fe, Pb, Ru, Os, Rh, Ir, Pd, Pt, Cu, Ag, Au, Zn, Cd, B, Al, Ga, Sn, In, Ge, P, As, Sb, Bi, S, Se, or tellurium.

In some embodiments, the transition metal oxide may be vanadium oxide, lithium vanadium oxide, and the like.

In one embodiment, the electrode active material may be preferably natural graphite, artificial graphite, Si, SiOₓ (0<x<2), a Si-containing alloy, Sn, SnO₂, a Sn-containing alloy, Ag, Al, or a combination thereof.

The binder improves binding properties between the electrode active material and the acrylonitrile-based resin and also attaches the electrode active material on the current collector. The binder includes a non-water-soluble binder, a water-soluble binder, or a combination thereof. The non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. The water-soluble binder includes a styrene-butadiene rubber, an acrylated styrene-butadiene rubber, polyvinyl alcohol, sodium polyacrylate, a copolymer of propylene and a C2 to C8 olefin, a copolymer of (meth)acrylic acid and (meth)acrylic acid alkyl ester, or a combination thereof. When the water-soluble binder is used as a negative electrode binder, a cellulose-based compound may be further used to provide viscosity. The cellulose-based compound includes one or more of carboxylmethyl cellulose, hydroxypropylmethyl cellulose, methyl cellulose, or alkali metal salts thereof. The alkali metal may be Na, K, or Li. The cellulose-based compound may be included in an amount of about 0.1 parts by weight to about 3 parts by weight based on 100 parts by weight of the negative active material.

In some embodiments, the electrode active material layer may further include a conductive material.

The conductive material is included to improve electrode conductivity. Any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

In some embodiments, the electrode active material layer may be formed on the current collector. In some embodiments, the current collector may include aluminum, a copper foil, a nickel foil, a stainless steel foil, a titanium foil, a nickel foam, a copper foam, a polymer substrate coated with a conductive metal, or a combination thereof, but is not limited thereto.

The electrode, for example having an active mass density of about 1.60 g/cc to about 2.2 g/cc according to one embodiment may have an increased impregnating rate of an electrolyte solution by about 20 volume % to about 80 volume %, and specifically, about 40 volume % to about 80 volume % relative to an electrode without an acrylonitrile-based resin. That is, the amount of the electrolyte impregnated in the electrode according to one embodiment is increased by about 20 volume % to about 80 volume % to that of an electrolyte impregnated in an electrode without the acrylonitrile-based resin. As the electrode has an increased impregnating rate of an electrolyte solution within the range, the rechargeable lithium battery having improved cycle-life characteristics and improved charge and discharge characteristics at a high rate may be accomplished. The increased impregnating rate of an electrolyte solution may be measured by using a dipping measurement system. For example, the electrode active material layer composition for an electrode active material layer is coated on a current collector to provide an electrode, then the electrode is loaded on a scale of the dipping measurement system, and then the electrode is impregnated in the electrolyte solution at about 0.5 mm to 2.0 mm of the end thereof to measure the amount of electrolyte solution permeated in the electrode according to the capillary phenomenon.

The electrode, for example, having an active mass density of about 1.60 g/cc to about 2.2 g/cc according to one embodiment may have an adherence force of about 0.6 gf/mm to about 3.5 gf/mm and specifically, about 0.8 gf/mm to about 1.4 gf/mm. By providing the electrode with the ranged adherence force, the rechargeable lithium battery having improved cycle-life characteristics and improved charge and discharge characteristics at a high rate may be accomplished. The adherence force may be determined by measuring the longitudinal force when the electrode is attached on and detached from the glass surface coated with adhesive having an area of about 1.0 cm² to 3.0 cm².

In some embodiments, the electrode may be prepared by coating an electrode active material layer composition on a current collector followed by drying and compressing it.

In some embodiments, the current collector is the same as described above.

In some embodiments, the electrode active material layer composition may include an electrode active material, a binder, and a foaming agent, and may further include a conductive material.

In some embodiments, the electrode active material, binder, foaming agent, and conductive material may be the same as described above.

In some embodiments, the foaming agent may be included in an amount of about 0.001 wt % to about 1.1 wt % based on the total amount of the electrode active material layer. In some embodiments, the foaming agent may be included in an amount of about 0.005 wt % to about 0.2 wt % based on the total amount of the electrode active material layer. When using the foaming agent within the preceding ranges, the wettability of electrolyte solution into the electrode is improved, and the adherence force of electrode may be improved.

In some embodiments, the electrode may be at least one of a positive electrode and a negative electrode in a rechargeable lithium battery.

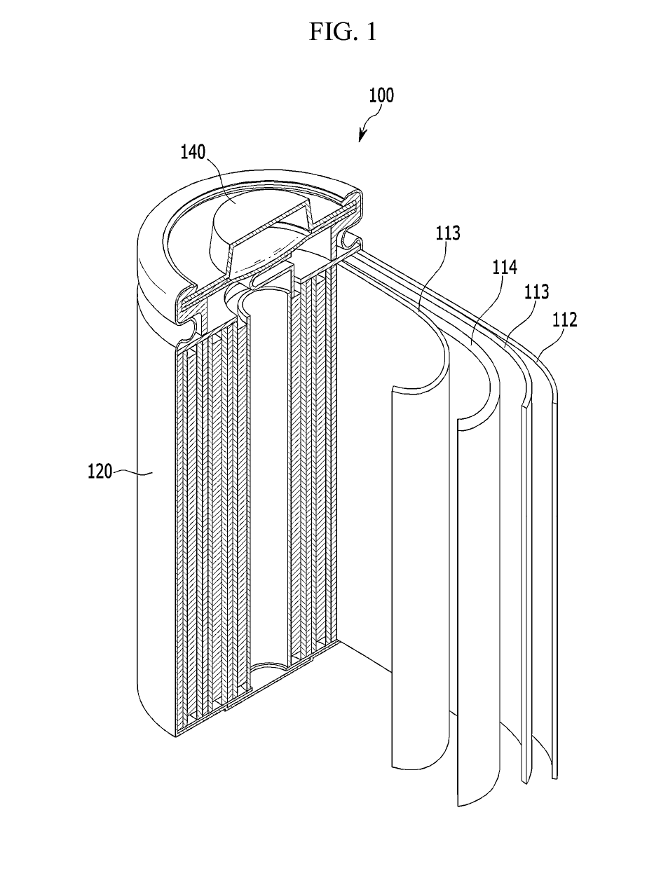

Hereafter, a rechargeable lithium battery including the electrode is described with reference to FIG. 1.

FIG. 1 is a schematic view of a rechargeable lithium battery according to one embodiment.

Referring to FIG. 1, the rechargeable lithium battery 100 includes an electrode assembly including a positive electrode 114, a negative electrode 112 facing the positive electrode 114, a separator 113 between the positive electrode 114 and negative electrode 112, and an electrolyte (not shown) impregnating the positive electrode 114, negative electrode 112, and separator 113, a battery case 120 housing the electrode assembly, and a sealing member 140 sealing the battery case.

At least one of the positive electrode and the negative electrode is the electrode described above.

In some embodiments, the electrolyte solution includes a non-aqueous organic solvent and a lithium salt.

The non-aqueous organic solvent serves as a medium for transmitting ions taking part in the electrochemical reaction of a battery. In some embodiments, the non-aqueous organic solvent may be selected from a carbonate-based, ester-based, ether-based, ketone-based, alcohol-based, or aprotic solvent.

In some embodiments, the carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and the like.

When the linear carbonate compounds and cyclic carbonate compounds are mixed, an organic solvent having high dielectric constant and low viscosity can be provided. The cyclic carbonate and the linear carbonate are mixed together in a volume ratio ranging from about 1:1 to about 1:9.

In some embodiments, the ester-based solvent may include, for example n-methylacetate, n-ethylacetate, n-propylacetate, dimethylacetate, methylpropionate, ethylpropionate, γ-butyrolactone, decanolide, valerolactone, mevalonolactone, caprolactone, or the like. In some embodiments, the ether solvent may include, for example dibutylether, tetraglyme, diglyme, dimethoxyethane, 2-methyltetrahydrofuran, tetrahydrofuran, and the like, and the ketone-based solvent may include cyclohexanone, and the like. In some embodiments, the alcohol-based solvent may include, for example ethyl alcohol, isopropyl alcohol, and the like.

In some embodiments, the non-aqueous organic solvent may be used singularly or in a mixture. When the organic solvent is used in a mixture, the mixture ratio can be controlled in accordance with a desirable battery performance.

In some embodiments, the non-aqueous electrolyte may further include an overcharge inhibitor additive such as ethylenecarbonate, pyrocarbonate, or the like.

The lithium salt is dissolved in an organic solvent, supplies lithium ions in a battery, basically operates the rechargeable lithium battery, and improves lithium ion transportation between positive and negative electrodes therein.

In some embodiments, the lithium salt may include LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), (where x and y are natural numbers of 1 to 20, respectively), LiCl, LiI, LiB(C₂O₄)₂ (lithium bis(oxalato) borate), or a combination thereof, as a supporting electrolytic salt.

In some embodiments, the lithium salt may be used in a concentration ranging from about 0.1 M to about 2.0 M. When the lithium salt is included within the above concentration range, an electrolyte may have improved performance and lithium ion mobility due to optimal electrolyte conductivity and viscosity.

In some embodiments, the separator 113 may include any materials commonly used in the conventional lithium battery as long as separating a negative electrode 112 from a positive electrode 114 and providing a transporting passage for lithium ions. In other words, the separator 113 may be made of a material having a low resistance to ion transportation and an improved impregnation for an electrolyte. For example, the material may be selected from glass fiber, polyester, polyethylene, polypropylene, polytetrafluoroethylene (PTFE), or a combination thereof. It may have a form of a non-woven fabric or a woven fabric. For example, a polyolefin-based polymer separator such as polyethylene, polypropylene or the like is mainly used for a lithium ion battery. In order to ensure the heat resistance or mechanical strength, a coated separator including a ceramic component or a polymer material may be used. Selectively, it may have a mono-layered or multi-layered structure.

Hereinafter, the embodiments are illustrated in more detail with reference to examples. However, the following are exemplary embodiments and are not limiting.

Furthermore, what is not described in this specification can be sufficiently understood by those who have knowledge in this field and will not be illustrated here.

### EXAMPLES

### Example 1

98 wt % of natural graphite, 1 wt % of carboxylmethyl cellulose (CMC), 1 wt % of styrene-butadiene rubber (SBR), and 0.1 part by weight of a foaming agent including an acrylonitrile-based resin (Matsumoto Yushi-Seiyaku Co., Ltd, Osaka, Japan; FN-80SDE, particle average diameter: 20 μm to 40 μm) (based on total 100 parts by weight of the natural graphite, the CMC, and the SBR) were mixed and then dispersed in water to provide a negative active material layer composition. The negative active material layer composition was coated on a copper foil having a thickness of 15 μm and dried and compressed to provide a negative electrode having an active mass density of 1.8 g/cc.

The counter electrode was a lithium metal, and the negative electrode and the lithium metal were inserted in a battery case and injected with an electrolyte solution to provide a half-cell.

The electrolyte solution was prepared by dissolving LiPF₆ having a concentration of 1.15M in a mixed solution of ethylene carbonate (EC), diethyl carbonate (DEC), and fluoroethylene carbonate (FEC) at a mixing volume ratio of 5:70:25.

### Example 2

A half-cell was fabricated in accordance with the same procedure as in Example 1, except that 98 wt % of natural graphite, 1 wt % of carboxylmethyl cellulose (CMC), 1 wt % of styrene-butadiene rubber (SBR), and 0.2 parts by weight of a foaming agent including an acrylonitrile-based resin (Matsumoto, FN-80SDE, particle average diameter: 20 μm to 40 μm) (based on total 100 parts by weight of the natural graphite, the CMC, and the SBR) were mixed and dispersed in water to provide a negative active material layer composition.

### Example 3

A half-cell was fabricated in accordance with the same procedure as in Example 1, except that 98 wt % of natural graphite, 1 wt % of carboxylmethyl cellulose (CMC), 1 wt % of styrene-butadiene rubber (SBR), and 0.1 parts by weight of a foaming agent including an acrylonitrile-based resin (Matsumoto, F-80DE, particle average diameter: 90 μm to 100 μm) (based on total 100 parts by weight of the natural graphite, the CMC, and the SBR) were mixed and dispersed in water to provide a negative active material layer composition.

### Example 4

A half-cell was fabricated in accordance with the same procedure as in Example 1, except that 98 wt % of natural graphite, 1 wt % of carboxylmethyl cellulose (CMC), 1 wt % of styrene-butadiene rubber (SBR), and 0.1 parts by weight of a foaming agent including an acrylonitrile-based resin (Matsumoto, F-65DE, particle average diameter: 40 μm to 60 μm) (based on total 100 parts by weight of the natural graphite, the CMC, and the SBR) were mixed and dispersed in water to provide a negative active material layer composition.

### Example 5

A half-cell was fabricated in accordance with the same procedure as in Example 1, except that 98 wt % of natural graphite, 1 wt % of carboxylmethyl cellulose (CMC), 1 wt % of styrene-butadiene rubber (SBR), and 0.5 parts by weight of a foaming agent including an acrylonitrile-based resin (Kumyang, Seoul, Korea; CAPL3, size: about 5 to about 15 μm) (based on total 100 parts by weight of the natural graphite, the CMC, and the SBR) were mixed and dispersed in water to provide a negative active material layer composition.

### Example 6

A half-cell was fabricated in accordance with the same procedure as in Example 1, except that 98 wt % of artificial graphite, 1 wt % of carboxylmethyl cellulose (CMC), 1 wt % of styrene-butadiene rubber (SBR), and 0.1 parts by weight of a foaming agent including an acrylonitrile-based resin (Matsumoto, FN-80SDE, particle average diameter: 20 μm to 40 μm) (based on total 100 parts by weight of the natural graphite, the CMC, and the SBR) were mixed and dispersed in water to provide a negative active material layer composition.

### Example 7

A half-cell was fabricated in accordance with the same procedure as in Example 1, except that 98 wt % of natural graphite, 1 wt % of carboxylmethyl cellulose (CMC), 1 wt % of styrene-butadiene rubber (SBR), and 0.2 parts by weight of a foaming agent including an acrylonitrile-based resin (Matsumoto, FN-80SDE, particle average diameter: 20 μm to 40 μm) (based on total 100 parts by weight of the natural graphite, the CMC, and the SBR) were mixed and dispersed in water to provide a negative active material layer composition. The negative active material layer composition was coated on a copper foil having a thickness of 15 μm and dried and compressed to provide a negative electrode having an active mass density of 1.70 g/cc.

Using the negative electrode, a rechargeable lithium battery cell was fabricated in accordance with the same procedure as in Example 1.

### Comparative Example 1

A half-cell was fabricated in accordance with the same procedure as in Example 1, except that 98 wt % of natural graphite, 1 wt % of carboxylmethyl cellulose, and 1 wt % of styrene-butadiene rubber were mixed and dispersed in water to provide a negative active material layer composition.

### Comparative Example 2

A half-cell was fabricated in accordance with the same procedure as in Example 1, except that 98 wt % of natural graphite, 1 wt % of carboxylmethyl cellulose (CMC), 1 wt % of styrene-butadiene rubber (SBR), and 0.5 parts by weight of a foaming agent with an azodicarbon amide structure (Kum Yang, ACL2, size: about 15 μm) (based on total 100 parts by weight of the natural graphite, the CMC, and the SBR) were mixed and dispersed in water to provide a negative active material layer composition.

### Evaluation Example 1

### Scanning Electron Microscope (SEM) Photograph Analysis of Electrode

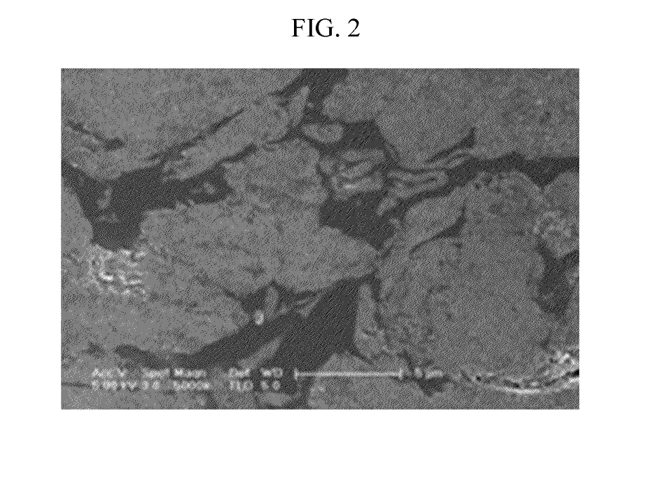

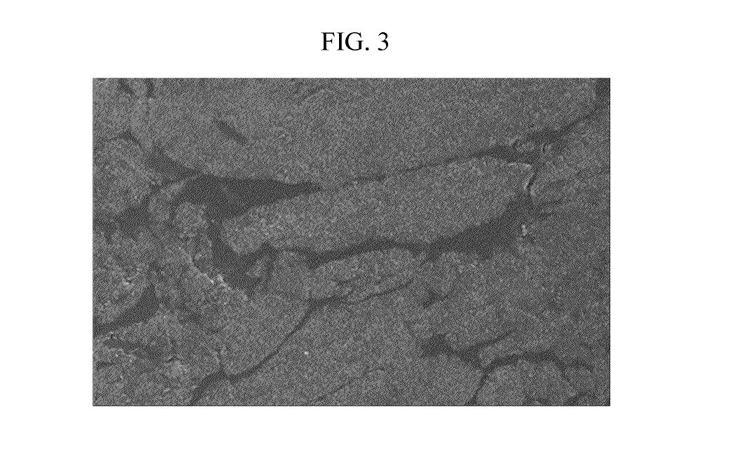

FIG. 2 is a scanning electron microscope (SEM) photograph of the negative electrode according to Example 3, and FIG. 3 is a scanning electron microscope (SEM) photograph of the negative electrode according to Comparative Example 1.

In FIG. 2, the cavity presented is larger than compared to the cavity in FIG. 3, which is provided by a foaming agent. Since the electrode having a high active mass density according to one embodiment has a huge impregnating path of electrolyte solution therein, the electrolyte solution may be easily impregnated, and the reservoir of electrolyte solution may be secured to eliminate the depletion region of electrolyte solution.

### Evaluation Example 2

### Electrolyte Solution Impregnation Property Analysis

The electrodes of Examples 1, 2, 5, 6 and 7 and Comparative Examples 1 and 2 were measured for the wettability increase rate using the wettability measurement system according to the following method, and the results are shown in the following Table 1.

Each negative active material layer composition of Examples 1, 2, 5, 6 and 7 and Comparative Examples 1 and 2 was coated on both surfaces of a copper foil having a thickness of 15 μm to provide a negative electrode in a size of 3×3 cm², and the obtained negative electrode was loaded on a upper scale of dipping measurement system. Then the negative electrode was impregnated in the electrolyte solution at 1 mm end thereof to measure the amount of drawing the electrolyte solution into the negative electrode according to the capillary phenomenon. In the following Table 1, the impregnation rate was obtained from the each amount of electrolyte impregnated in the electrode according to Examples 1, 2, 5, 6, 7, and Comparative Example 2, to the amount of the electrolyte impregnated in the electrode according to Comparative Example 1.

TABLE 1

| | Impregnation rate of an electrolyte solution |
|---|---|
| | (relative to the reference sample) (volume %) |
| Example 1 | 55 |
| Example 2 | 32 |
| Example 5 | 25 |
| Example 6 | 37 |
| Example 7 | 72 |
| Comparative | reference sample |
| Example 1 | |
| Comparative | 15 |
| Example 2 | |

As shown in Table 1, the electrodes according to Examples 1 to 7 fabricated using a foaming agent including an acrylonitrile-based resin had an increased impregnation rate relative to the electrode according to Comparative Example 1 made using no foaming agent and the electrode according to Comparative Example 2 including a foaming agent including no acrylonitrile-based resin.

### Evaluation 3

### Adherence Force Analysis of Electrode

The electrodes according to Examples 1 to 4 and 7 and Comparative Example 1 were measured for the adherence force using an adherence force measurer, the results are shown in Table 2.

The adherence force was determined by measuring the longitudinal force when the electrodes obtained from Examples 1 to 4 and 7 and Comparative Example 1 were attached on the glass surface coated with adhesive having an area of 1 cm² and then detached.

TABLE 2

| | Adherence force of electrode (gf/mm) |
|---|---|
| Example 1 | 0.93 |
| Example 2 | 1.12 |
| Example 3 | 0.95 |
| Example 4 | 1.4 |
| Example 7 | 0.94 |
| Comparative | 0.84 |
| Example 1 | |

As shown in Table 2, the electrodes according to Examples 1 to 4 and 7 fabricated using a foaming agent including an acrylonitrile-based resin had higher adherence force than the electrode according to Comparative Example 1 including no foaming agent.

### Evaluation 4

### Charge and Discharge Characteristics at a High Rate

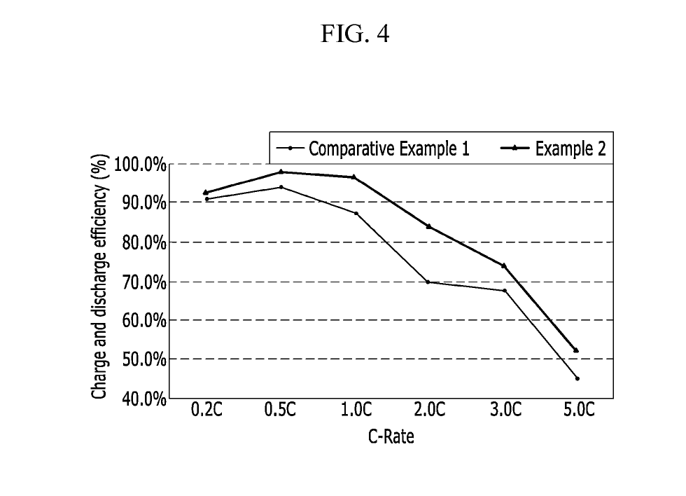

The half-cells according to Example 2 and Comparative Example 1 were charged and discharged in accordance with the following method, and the results are shown in FIG. 4.

Charge: 0.2C charge, cut-off at 0.01C

Discharge: 0.2C, 0.5C, 1.0C, 2.0C, 3.0C, 5.0C, 1.5V cut-off

FIG. 4 is a graph showing the charge and discharge characteristics at a high rate of rechargeable lithium battery cells according to Example 2 and Comparative Example 1.

Referring to FIG. 4, the electrode according to Example 2 fabricated by using a foaming agent including an acrylonitrile-based resin to provide the acrylonitrile-based resin in the electrode had superior charge and discharge characteristics at a high rate to Comparative Example 1 including no foaming agent including an acrylonitrile-based resin.

### Evaluation 5

### Cycle-Life Characteristic

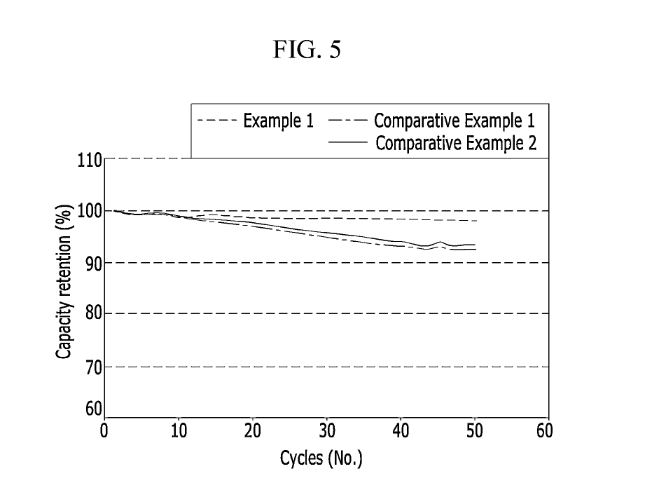

The half-cells obtained from Example 1 and Comparative Examples 1 and 2 were charged and discharged according to the following method, and the results are shown in FIG. 5.

Charge: 1.0C CC/CV mode

Discharge: 0.01C cut-off/1.0C CV mode 1.5V cut-off

FIG. 5 is a graph showing the cycle-life characteristics of rechargeable lithium battery cells according to Example 1 and Comparative Examples 1 and 2.

As shown in FIG. 5, the capacity retention was changed to a lesser degree during the cycle using the electrode from Example 1 fabricated using the foaming agent including an acrylonitrile-based resin and the cycle-life characteristics were improved compared to Comparative Example 1 including no foaming agent and Comparative Example 2 including a foaming agent including no acrylonitrile-based resin.

In the present disclosure, the terms “Example,” “Comparative Example” and “Evaluation Example” are used arbitrarily to simply identify a particular example or experimentation and should not be interpreted as admission of prior art. While this embodiments have been described in connection with what is presently considered to be practical exemplary embodiments, it is to be understood that the embodiments are not limited to the disclosed embodiments, but, on the contrary, is intended to cover various modifications and equivalent arrangements included within the spirit and scope of the appended claims.

What is claimed is:

1. An electrode for a rechargeable lithium battery, comprising
a current collector; and
an electrode active material layer disposed on the current collector,
wherein the electrode active material layer includes an electrode active material, a binder, an acrylonitrile-based resin, and one or more pores.

2. The electrode for a rechargeable lithium battery of claim 1, wherein the acrylonitrile-based resin is included in an amount of about 0.001 wt % to about 1.1 wt % based on the total amount of the electrode active material layer.

3. The electrode for a rechargeable lithium battery of claim 1, wherein: the pore has a size of about 0.1 μm to about 100 μm.

4. The electrode for a rechargeable lithium battery of claim 1, wherein the pore has a volume of about 15 to about 40 volume %.

5. The electrode for a rechargeable lithium battery of claim 1, wherein the electrode active material comprises natural graphite, artificial graphite, Si, SiOₓ (0<x<2), a Si-containing alloy, Sn, SnO₂, a Sn-containing alloy, Ag, Al, or a combination thereof.

6. The electrode for a rechargeable lithium battery of claim 1, wherein the electrode has an active mass density of about 1.60 g/cc to about 2.2 g/cc.

7. The electrode for a rechargeable lithium battery of claim 1, wherein the electrode has a dipping increase rate of an electrolyte solution ranging from about 20 volume % to about 80 volume % relative to an electrode without an acrylonitrile-based resin.

8. The electrode for a rechargeable lithium battery of claim 1, wherein: the electrode has an adherence force of about 0.6 gf/mm to about 3.5 gf/mm.

9. The electrode for a rechargeable lithium battery of claim 1, wherein the acrylonitrile-based resin is an acrylonitrile resin.

10. The electrode for a rechargeable lithium battery of claim 1, wherein the acrylonitrile-based resin is a copolymer comprising styrene and acrylonitrile.

11. A method of preparing an electrode for a rechargeable lithium battery, comprising
coating an electrode active material layer composition on a current collector,
wherein the electrode active material layer composition comprises an electrode active material, a binder, and a foaming agent including an acrylonitrile-based resin.

12. The method of claim 11, wherein: the electrode active material comprises natural graphite, artificial graphite, Si, SiOₓ (0<x<2), a Si-containing alloy, Sn, SnO₂, a Sn-containing alloy, Ag, Al, or a combination thereof.

13. The method of claim 11, wherein: the foaming agent is a particle having an average diameter in the range of about 2 μm to about 100 μm.

14. The method of claim 11, wherein: the foaming agent is included in an amount of about 0.001 wt % to about 1.1 wt % based on the total amount of the electrode active material layer composition.

15. A rechargeable lithium battery, comprising
the electrode according to claim 1; and
an electrolyte solution.
